(19) United States
(12) Patent Application Publication
(10) Pub. No.: US 2007/0255801 A1
(43) Pub. Date: Nov. 1, 2007

(54) Digital cable and satellite television remotely automated notice system

(76) Inventor: Robert M. Adler, West Palm Beach, FL (US)

Correspondence Address: MCHALE & SLAVIN, P.A., 2855 PGA BLVD, PALM BEACH GARDENS, FL, 33410, US

(21) Appl. No.: 11/414,899

(22) Filed: May 1, 2006

(51) Int. Cl. G06F 15/16

(52) U.S. Cl. 709/217

(57) ABSTRACT

A device and method for broadcasting advisory alerts via a central notification computer which is operable to broadcast advisory alerts to digital cable and satellite televisions. The advisory alerts are sent to television addresses stored in a subscriber database in a computer retrievable format. The subscriber database contains subscriber data sets which each include the electronic television address and at least one geographic location associated with the electronic television address. When an advisory alert is initiated, the affected geographical location is determined and a geographic area defined by a perimeter is associated with the advisory alert. An algorithm retrieves electronic device addresses associated with the geographic areas within the perimeter and the advisory alert is transmitted to the digital cable or satellite television addresses associated with the geographic areas within the perimeter.

### RELATED APPLICATIONS

This application is related to U.S. Pat. Nos. 6,401,095; 6,505,203; 6,581,073 and U.S. patent application Ser. No. 10/402,423 filed Mar. 28, 2003; Ser. No. 11/107,346 filed Apr. 15, 2005; and a continuation-in-part application of Ser. No. 11/373,517 filed Mar. 10, 2006 which is a continuation-in-part of Ser. No. 11/138,669 filed May 25, 2005, the contents of all patents and applications are herein incorporated by reference.

### FIELD OF THE INVENTION

The invention relates to communication systems, and in particular to a system and method for broadcasting advisory alerts over digital cable television and satellite television, on a subscriber basis.

### BACKGROUND OF THE INVENTION

The loss of one's personal property, whether by chance or as the result of theft, is often devastating. When the lost item is a living being, for example an elderly parent, a child or even a pet, the loss is catastrophic. While the loss of a child or a parent brings into action numerous government agencies, e.g. police departments, fire departments, the FBI, etc. there is no instant means to coordinate and disseminate the information regarding the lost person. If a pet is lost, there are no governmental agencies to contact for help with locating the pet.

For missing persons, the recovery rate is much greater than that of animals due to the persons' ability to communicate and the higher intensity of the search. However, the anxiety due to a prolonged search can produce psychological scars to both the missing person and the responsible adult. Further, the recovery rate is low for abducted persons and runaways where the cooperation of the subject is either prevented or not volunteered.

The options available to the pet owners are few. Putting up posters or a search performed by the owner which is often fruitless. Motor vehicles, euthanasia, predators, and starvation claim one of every two pets that never return home. Thus, what is lacking in the art is a notification system capable of providing a timely notification to a geographically sensitive area upon discovery of a lost person or pet.

There has also been a long recognized need to provide a means for unilateral emergency communications broadcast to the general public. Concerns about terrorists activities have only heightened the awareness that an efficient, far reaching public communications system is vital to public safety. Recently threats to the public have been limited to relatively smaller areas such as a single office building or a one city block area. Authorities do not want to alarm too many people without good and sufficient reason, so as to avoid a panic. Therefore what is needed is a means to broadcast an advisory alert to the majority of persons in a given area which is affected by the alert and not to persons not affected by the alert.

When people are at home they usually have access to some form of television. When people are at home during the day, the television is usually on as a source of background sound or to entertain small children. If an important news event occurs a person will hear an announcement and usually stop what they are doing to watch the news event. In many restaurants and public areas, such as airports, televisions are constantly on and tuned to the all news channels or a sporting event.

The pervasiveness of the Internet has a potential, unique in technological history, for widespread communication. Cable and satellite television has replaced broadcast television as the major medium to bring commercial television channels. Most people have access to the Internet at home and at work. Cable television and satellite television can, in most markets, provide programing of particular interest to a subscriber. This may be in the way of a paid subscription to a particular movie channel, as well as geographically limited signals such as that use by satellite television for repeating of local channels.

It would be highly advantageous to provide a means to simultaneously broadcast an advisory alert to such communication devices in order to reach a majority of the public with video and audio content. For example, a video screen with a predominant color may indicate a Homeland Security advisory level. A picture of a criminal may lead to their capture after authorities have been alerted be a member of the general public. A picture of a missing person or pet may facilitate recovery of the person or pet.

More recently, the public has been made aware of the lack of information concerning dangerous criminals, such as sex offenders and others, especially their whereabouts within the community. When a sex offender becomes a predator, every minute that passes wherein the predator is not confined results in the endangerment of small children.

While the entire public may not be listening to commercial broadcasts at the time of an emergency, a majority of the public is reachable via some sort of electronic communication device. At a given time, most people have access to some sort of communication device such as land based telephones, cellular telephones, pagers, personal computers having Internet connections, PDA, fax machines, etc. The pervasiveness of personal electronic communication devices has a potential, unique in technological history, for widespread emergency communication.

It would therefore be highly advantageous to provide a means to simultaneously broadcast an advisory alert of any of the prior patent targets or the like communication device in order to reach the public with an advisory alert of a sexual predator that is in a geographical area. A picture of a predator sent to a target area where the predator is known to exist may also facilitate quick apprehension of such an individual.

U.S. Pat. Nos. 6,401,095; 6,505,203; and 6,581,073, issued to the present inventor, are directed to systems which use an algorithm to send geographically targeted e-mail or notices of an advisory event. These patents are directed to systems which utilize the Internet as an access point to provide information pertaining to missing persons, pet loss notification, or advisory alerts. The systems canvass specific geographic areas in a matter of seconds to aid in the location of a missing person or pet. The system utilizes an on-line enrollment form to distribute a photo of the lost person or pet via e-mail. Upon notification of a missing person or lost pet, the system initiates calculations, based upon the last known locations of the person or pet, to determine the most appropriate area for the search.

### SUMMARY OF THE INVENTION

Applicant proposes a system and method for broadcasting missing persons information and advisory alerts in text, pictorial and sound formats to an electronic device such as digital or satellite television on a subscriber basis. The missing persons information and advisory alerts originate from a central notification computer, each television has an address (an IP address) which is associated with at least one geographic location in a subscriber database located on the central notification computer. When a missing persons or advisory alert is initiated the event triggering the alert is associated with a geographic area having a defined perimeter, the geographic area typically being that which would be affected by the event. An algorithm retrieves the addresses of the televisions which are associated with the geographic locations located within the perimeter. The alert is then sent only to the retrieved addresses.

Thus, the invention can function as an on-line neighborhood crime watch service by providing a central monitoring station to receive telephonic or electronic reports from individual subscribers which are then transmitted to the televisions within the relevant areas.

In another embodiment, a television subscriber may subscribe to accept channel banners wherein the advisory alert is indicated by a banner crossing the screen. This banner may be directed to a particular geographically location and further limited to those paying for access to the banner. In this embodiment, only those customers that choose to receive an advisory notice are alerted, and of those customers the banner is limited to advisory alerts that are of concern in their geographical area.

A method of broadcasting missing persons and advisory alerts via communication networks is as follows: a central notification computer is provided which is operable to broadcast advisory alerts to TV addresses stored in a subscriber database in a computer retrievable format. The subscriber database contains subscriber data sets which each include a TV address and at least one geographic location associated with that address. When an alert is issued, the affected geographic area is determined and a geographic area defined by a perimeter is associated with the alert. An algorithm is activated to compute, from critical pertinent data, a geographical area or perimeter within which the lost person or pet is projected to have the highest probability of being resident. The alert is then transmitted to the TV addresses associated with the geographic area or perimeter.

The invention can further include the step of providing an advertising module executable at the notification computer which is configured to select advertisement content from a database of advertisers located within the geographical location associated with the advisory alert and further configured to provide the advertisement in conjunction with the advisory alert so as to pass the cost of the operation to the advertisers.

Accordingly, it is an objective of the instant invention to provide a subscriber-based advisory alert broadcast system which transmits advisory alerts to electronic devices such as digital cable and sattilite Televisions.

It is a further objective of the instant invention to provide a subscriber-based advisory alert broadcast system which maintains a subscriber database in which the addresses of the electronic devices are associated with at least one geographic location.

It is another objective of the instant invention to provide a subscriber-based advisory alert broadcast system which associates a geographical area with a given alert utilizing an algorithm.

It is a still another objective of the invention to provide a subscriber-based advisory alert broadcast system which provides a central monitoring station which can receive reports from individual subscribers, thus providing a localized interactive neighborhood crime watch service.

It is another objective of the invention is to provide a network between parents in geographical areas wherein if a parent spots a predator the parent can immediately contact all concerned parents in a geographical area of concern.

It is still another objective to provide a subscriber-based advisory alert broadcast system which provides central monitoring station which can receive event reports from individual subscribers, thus providing a localized interactive neighborhood crime watch service when a sexual offender or predator is known to be in the area.

It is yet another objective to provide a subscriber-based advisory alert broadcast system which does not require any modification to the end user equipment or software.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 schematically illustrates the elements and process of the advisory alert broadcast system of the invention;

FIG. 2 is an example of an advisory alert transmitted in text format for an emergency situation;

FIG. 3 is an example of an advisory alert transmitted in text format for a local neighborhood crime watch system;

FIG. 4 illustrates the structure of the data sets in the subscriber database; and

FIG. 5 is an example of the system architecture.

### DETAILED DESCRIPTION OF THE INVENTION

While the present invention is susceptible of embodiment in various forms, there is shown in the accompanying drawings and will hereinafter be described a presently preferred embodiment with the understanding that the present disclosure is to be considered an exemplification of the invention and is not intended to limit the invention to the specific embodiments illustrated.

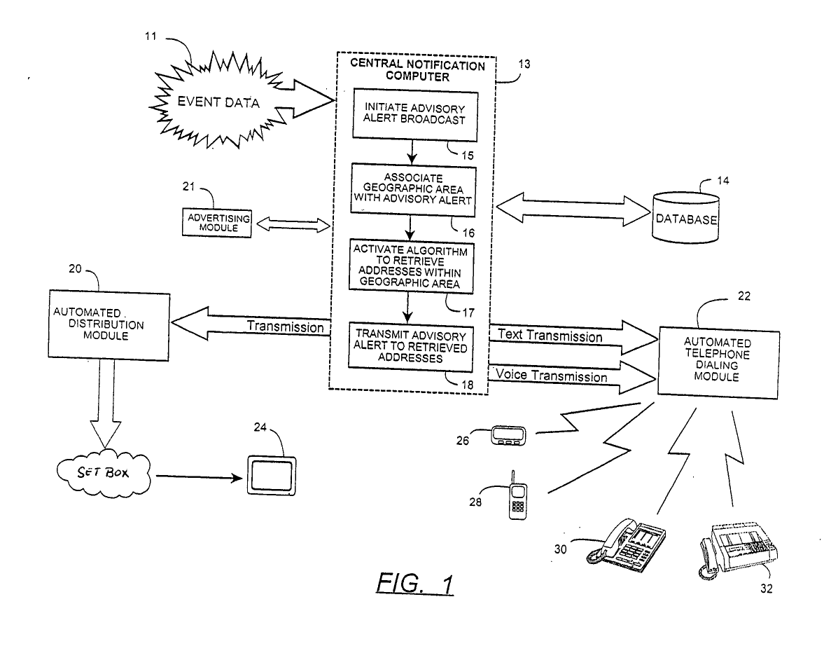

The present invention provides a missing persons and advisory alert system which transmits both video and audio messages to electronic devices such as Digital Cable and Satellite Television associated with a given geographic area. The structure of the overall system is schematically illustrated in FIG. 1. A central notification computer 13 is in communication with a database 14 of subscribers which are to receive missing persons and advisory alerts. The central notification computer 13 is shown as a single device for ease of description, however, the central notification computer 13 can be a plurality of computers in a hierarchal arrangement. The electronic device which receives the alerts can be any Digital Cable and Satellite Television or similar device 24. reception of Digital Cable and Satellite Television requires either a personal computer of a “set-top” box connected to a television. The reception device can either be configured to accept the transmission on a priority status, e.g. provide notice by interrupting a television program, employing a pop-up screen, use of a ticker tape display, notification of receipt of electronic mail, etc. . . . The database 14 includes a plurality of subscriber data sets which include the IP address of the television device and at least one geographical location associated with the device. The geographical location can be longitude and latitude coordinates which may be employed in a GPS system or device. The geographical locations could also be street addresses, etc.

An advisory alert is triggered by an event, such as a missing person, missing pet, emergency situation, local storm warning, etc. The broadcast of the advisory alert is initiated at the central notification computer 13 at step 15. A geographic area having a defined perimeter is associated with the advisory alert in step 16. This area is typically the general location which may be affected by the event or most likely to contain the missing person or pet. An algorithm is then employed in step 17 at the central notification computer to retrieve the addresses of the Digital Cable and Satellite Television or similar electronic devices for the subscribers associated with the locations within the defined perimeter. The advisory alert is then transmitted in both video and audio formats to the subscriber addresses. The video format may also contain text messages. As shown in FIG. 1 an alert message is sent to an automated distribution module 20, which sends notifications to subscribers with IP addresses which are associated with locations within the defined perimeter. The messages are received and viewed by the end users of Digital Cable and Satellite Television 24. The alerts may also be broadcast on a channel set aside for this service. The alert may interrupt other scheduled programming if warranted or run as an alert ticker or crawler at the bottom of scheduled programming. If the alert provider desires the subscribers tune to the alert channel, an alert ticker can be run at the bottom of scheduled programming instructing the subscribers to do so. This ticker and alert broadcasts will only be seen by those subscribers of the alert service who are located in the defined perimeter of a specific geographic area. Alternatively, the automated notification module 20 would send an alert message to telephones, pagers, etc. advising the subscriber of an advisory alert. After receiving the notification the subscriber would then turn on their television and tune to the specific channel on which the alerts are broadcast.

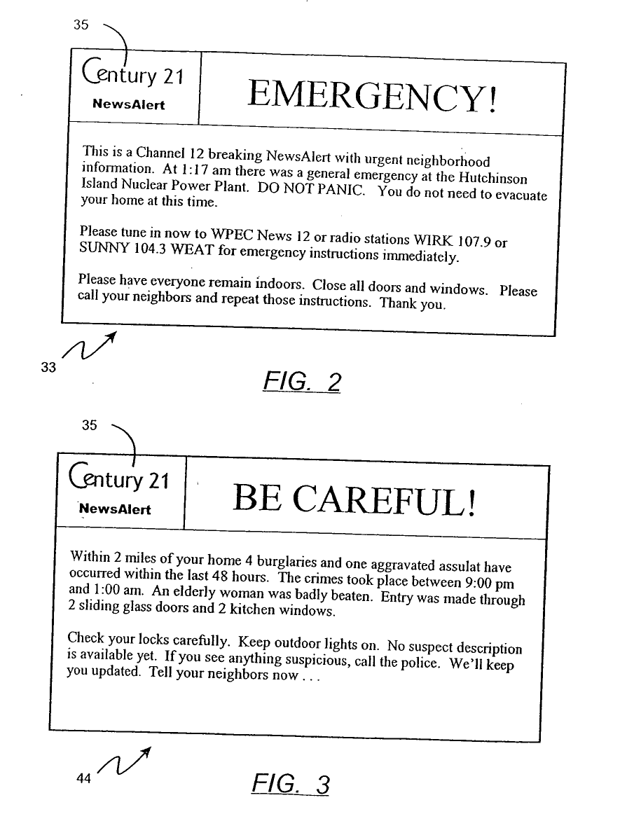

FIG. 2 illustrates an example of an advisory alert 33 for a hypothetical emergency situation to be broadcast as a text message. An audio message can be associated with the text message so that the recipient does not have to view the message. The information provided in the advisory alert 33 is geographically specific to the end user. An advertising field 35 can be juxtaposed with the advisory alert 33. This simultaneously delivers advertising content to the end users. To accomplish this an advertising module 21 is provided which is executable at the notification computer. The advertising module 21 selects advertisement content from a database of advertisers located within the specific geographic area associated with the advisory alert and then provides advertisement in conjunction with the advisory alert. For example if the alert is regarding a missing pet then companies affiliated with pet products and services in the specific geographic area will have their advertisement associated with the alert.

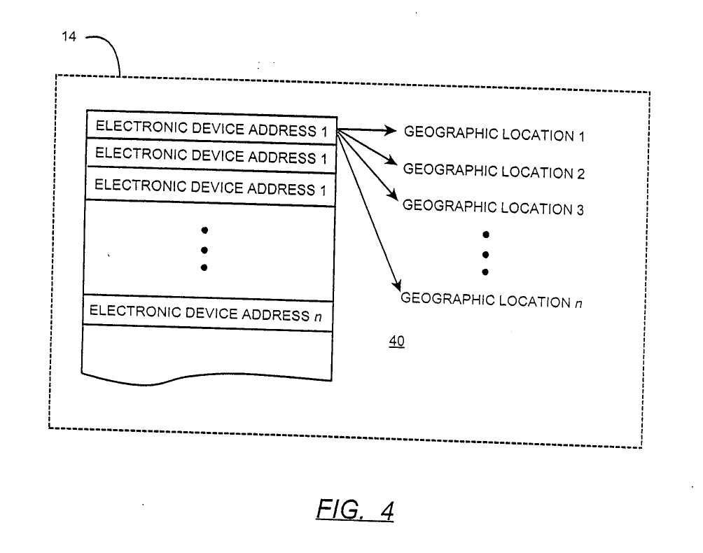

In another aspect of the invention, advisory alerts are disseminated based on information received from conventional sources, such as government based Emergency Alerting System (EAS) broadcasts, commercial news organizations, wire services, law enforcement agencies, etc.(e.g. a known criminal moving into a neighborhood, a sex offender being reclassified as a sexual predator, etc.). In a further aspect of the invention, event related data can originate from “grass roots” sources so as to provide an on-line neighborhood crime watch system. To implement such a system, an individual subscriber would have a means to provide event reports to a central monitoring station (provided with human operators) to receive reports which would correlate the information and then disseminate the appropriate advisory alerts through a central notification computer. This type of system, employing human operators, would also be utilized whenever a missing person was reported. As described above, the advisory alerts are geographically specific and are sent only to subscribers in the relevant geographic areas or neighborhoods. The reports can include direct observations of criminal acts or suspicious activity, traffic accidents, sightings of lost animals, etc. An example of an advisory alert 44 which may be sent in an “neighborhood crime watch” application of the invention is shown in FIG. 3. In this “neighborhood crime watch” arrangement, the system of the invention provides nearly instantaneous transmission of relevant event data to the affected parties since the event data does not have to filter through the conventional news dissemination entities. The method of the invention can thus provide a neighborhood based communication network which links the members of the community to one another and rapidly disseminates information vital for the safety of the community.

FIG. 4 illustrates an example of the data sets 40 stored in the subscriber database 14. As shown in FIG. 4, each electronic device address 41₁₋ₙ can be associated with a plurality of geographical locations 43₁₋ₙ in the subscriber database. A subscriber may want to monitor events taking place in any number of geographic areas at once. For example, a subscriber's address can be simultaneously associated with (a) the subscriber's home neighborhood, (b) the subscriber's workplace neighborhood, (c) the school attended by the subscriber's children and (d) the neighborhood of a relative. In addition, it may be desired to provide a temporary geographic association with a subscriber. For example, a subscriber might be attending a large event, such as a concert or sporting event, and would like to remain informed of any criminal activity or other hazardous situation which may take place in the immediate area of the event. In this scenario, the address of the subscriber would be associated with the event location only for a limited time around the event.

Alerts transmitted in accordance with the system and method of the present invention will necessarily range from high level situations (missing persons requiring medical attention, terrorists attacks, evacuation orders, etc.) to relatively low level alert situations (automobile accidents, petty thefts). The advisory alerts can be graded, for example, on a numerical scale, to indicate the relative degree of importance to the recipient. In an alternative embodiment of the invention, a means is provided for a subscriber to select the lowest threshold level of advisory alert they wish to receive at a selected address. In this way, a subscriber can choose to receive higher alert advisories so that the subscriber is not inundated with low level alerts.

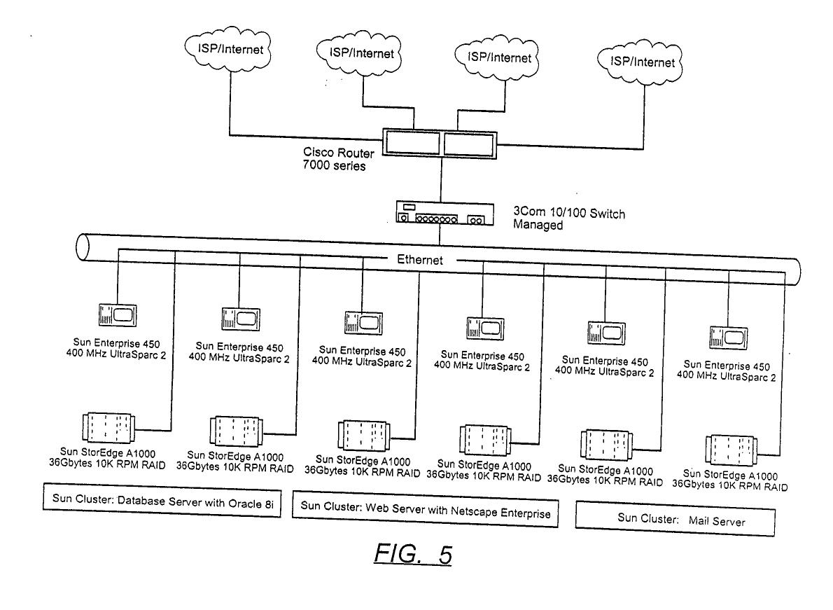

With reference to FIG. 5, a diagram exemplifying the system architecture is shown. The notification system will be divided into four main parts:
1) processing/database system;
2) messaging system;
3) web server;
4) network infrastructure. All of these parts are off-the-shelf items having the requisite functions. The particular manufacturer and model is of no import but merely serves as an example.

The database server may rely on two SUN ENTERPRISE 450 servers or equivalents configures to operate as a cluster. ORACLE SERVER EE 8i, coupled with ORACLE PARALLEL SERVER or equivalents will optimize the SUN cluster architecture to provide an optimum database system. Data processing may be handled by ORACLE APPLICATION SERVER ENTERPRISE and ORACLE INTERMEDIA or equivalents.

The messaging system may be based upon a cluster architecture also and may utilize at least two SUN ENTERPRISE 2 Model 1400 servers to support SUN's SENDMAIL messaging server.

Using the same physical architecture as the messaging system, the web server may implement NETSCAPE ENTERPRISE SERVER.

The network/telecom may utilize a device having the capabilities of a CISCO 7500 Series router, particularly preferred is a CISCO 7576. Desirable characteristics are LAN/WAN service support, redundancy, reliability and performance. Scalability is accomplished due to a bandwidth extensible to 4 Gbps. Switching is accomplished via a 3COM SUPERSTACK II Switch 3300 or equivalent.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of broadcasting advisory alerts to digital cable and satellite television comprising:
providing a means to transmit an advisory alert to a plurality of television addresses from a central notification computer;
maintaining a subscriber database of television addresses to receive the advisory alerts, wherein the subscriber database includes a plurality of subscriber data sets, said data sets include the electronic device address and at lest one geographic location associated with the television address;
maintaining said subscriber database in a computer retrievable format for access by said central notification computer;
providing a means to initiate an advisory alert broadcast from said central notification computer;
associating a geographic area with the advisory alert, wherein said geographic area is defined by a perimeter;
activating an algorithm to retrieve said television address associated with said geographical areas within said perimeter; and
transmitting said advisory alert to said television address associated with said geographic areas within said perimeter.

2. The method of claim 1, further including the step of providing an advertising module at said notification computer, wherein said advertising module is configured to select advertisement content from a database of advertisers located within the geographical area associated with the advisory alert, and further configured to provide the advertisement in conjunction with the advisory alert.

3. An advisory alert notification computer for creation of notifications of advisory alerts to be sent over digital cable and satellite television comprising:
means to provide a central notification computer in communication with the global computer network;
means to transmit an advisory alert to a plurality of television addresses from said central notification computer;
means for maintaining a subscriber database of television addresses to receive the advisory alerts, wherein said subscriber database includes a plurality of subscriber data sets, said data sets include the television address and at least one geographic location associated with the television address;
means for maintaining said subscriber database in a computer retrievable format for access by said central notification computer;
means to initiate an advisory alert broadcast from said central notification computer;
means to associate a geographical area with the advisory alert, wherein said geographical area is defined by a perimeter;
means employing an algorithm for retrieving the television addresses associated with said geographical areas within said perimeter; and means to transmit said advisory alert to said television addresses associated with said geographic areas within said perimeter.

4. The advisory alert notification computer of claim 3, wherein the television is coupled to a set-top box.

5. The advisory alert notification computer of claim 3, further including means for providing an advertising module at said notification computer, wherein said advertising module further includes means to select advertisement content from a database of advertisers located within the geographical area associated with the advisory alert, and further including means to provide the advertisement in conjunction with the advisory alert.
